(19) United States
(12) Patent Application Publication
(10) Pub. No.: US 2010/0120380 A1
(43) Pub. Date: May 13, 2010

(54) METHOD FOR COMMUNICATING WITH OTHER RADIO APPARATUSES AND RADIO APPARATUS USING THE METHOD

(76) Inventors: Yoshiyuki Otani, Anpachi-gun (JP); Kiyoshige Ito, Anpachi-gun (JP)

Correspondence Address: MCDERMOTT WILL & EMERY LLP, 600 13TH STREET, N.W., WASHINGTON, DC, 20005-3096, US

(21) Appl. No.: 12/557,924

(22) Filed: Sep. 11, 2009

(30) Foreign Application Priority Data
Sep. 11, 2008 (JP) 2008-233951

(51) Int. Cl. H04B 1/02; H04B 17/00

(52) U.S. Cl. 455/103; 455/115.1

(57) ABSTRACT

A processing unit receives the input of image data sequentially. A specifying unit specifies a synchronization period for the sequentially inputted image data. A measurement unit measures the characteristics of a radio channel over the specified synchronization period. The processing unit stores the measured characteristics of a radio channel in radio packets and transmits the radio packets storing the measured characteristics to other radio apparatuses, and also stores the sequentially inputted image data in the radio packets and transmits the radio packets storing the image data to the other radio apparatuses.

### CROSS-REFERENCE TO RELATED APPLICATIONS

This application is based upon and claims the benefit of priority from the prior Japanese Patent Application No. 2008-233951, filed on Sep. 11, 2008, the entire contents of which are incorporated herein by reference.

### BACKGROUND OF THE INVENTION

1. Field of the Invention

The present invention relates generally to a communication technology and, in particular, to a method for performing communications with other radio apparatuses and a radio apparatus utilizing the communication method.

2. Description of the Related Art

JPEG (Joint Photographic Experts Group) is one of international standards for compression technology for compressing still images. In JPEG, original data (hereinafter referred to as “original frames”) are subjected to DCT (Discrete Cosine Transform), quantization and entropy coding. The format of data compressed under JPEG is such that marker (hereinafter referred to as “header marker”), header, image data and marker (hereinafter referred to as “end marker”) are assigned in this order starting from the header position. Note that the image data correspond to data where the original frames have been compressed.

An on-vehicle camera is installed in a vehicle to avoid the collision of vehicles such as automobiles and improve the driving safety, and images picked up by the on-vehicle camera are displayed on an on-vehicle monitor. A driver grasps surrounding circumstances of the vehicle through not only checking but also the images displayed on the on-vehicle monitor. In general, the on-vehicle monitor is installed near a driver's seat and the on-vehicle camera is installed in a front and/or rear part of the vehicle, so that the on-vehicle monitor and the on-vehicle cameras are remotely positioned. Accordingly, images picked up by the on-vehicle camera need to be transmitted to the on-vehicle monitor. To save time for installation, the use of a wireless communication system such as wireless LAN (Local Area Network) is preferable over that of wired cables. In consideration of transmission capacity in the wireless LAN, images to be transmitted are subjected to the aforementioned compression technology.

When two or more vehicles to which such on-vehicle cameras are installed move closer to one another and when wireless LAN access points provided outside the vehicles get closer to the vehicles, interference may occur in wireless LAN. In such a case, the communications may not be performed normally. To avoid this, it is preferred that mutually different frequency channels be used. However, since the number of frequency channels is limited, the interference may occur as the vehicles move, for instance. Depending on a frequency channel used, interference may occur between a vehicle and radar. When the interference occurs and the images cannot be transmitted normally, the safety may be jeopardized, which is not desirable at all. Therefore, the frequency channel must be appropriately switched depending on the circumstances where the radio communication is being performed.

### SUMMARY OF THE INVENTION

The present invention has been made in view of the foregoing circumstances, and a purpose thereof is to provide a technology for suitably selecting a frequency channel in accordance with circumstances where radio communication is performed.

In order to resolve the above problems, a radio apparatus according to one embodiment of the present invention comprises: an input unit which receives input of image data sequentially; a specifying unit which specifies a synchronization period for the image data sequentially inputted by the input unit; a measurement unit which measures the characteristics of a radio channel over the synchronization period specified by the specifying unit; and a transmitter which stores the characteristics of a radio channel measured by the measurement unit in a radio packet and transmits the radio packet storing the measured characteristics thereof to another radio apparatus and which further stores the image data sequentially inputted by the input unit in the radio packet and transmits the radio packet storing said image data to the another radio apparatus.

Another embodiment of the present invention relates to a communication method. This method comprises: receiving input of image data sequentially; specifying a synchronization period for the image data inputted sequentially; measuring the characteristics of a radio channel over the specified synchronization period; and storing the measured characteristics of a radio channel in a radio packet, transmitting the radio packet storing the measured characteristics thereof to another radio apparatus, further storing the sequentially inputted image data in the radio packet and transmitting the radio packet storing said image data to the another radio apparatus.

Optional combinations of the aforementioned constituting elements, and implementations of the invention in the form of methods, apparatuses, systems, recording mediums, computer programs and so forth may also be practiced as additional modes of the present invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 shows a structure of a communication system according to an exemplary embodiment of the present invention;

FIG. 2 shows a structure of an on-vehicle camera apparatus shown in FIG. 1;

FIGS. 3A to 3C show operation timings in the on-vehicle camera apparatus shown in FIG. 2;

FIG. 4 shows a data structure of measurement conditions stored in a storage shown in FIG. 2;

FIG. 5 shows a structure of an on-vehicle monitor apparatus shown in FIG. 1;

FIG. 6 shows a data structure of a table, containing measurement results, stored in a storage shown in FIG. 5;

FIG. 7 shows a data structure of a threshold value, with which to determine a measurement period, stored in a measurement unit shown in FIG. 5;

FIG. 8 is a sequence diagram showing a procedure for updating a table in the communication system shown in FIG. 1:

FIG. 9 is a sequence diagram showing a procedure for switching a frequency channel in the communication system shown in FIG. 1;

FIG. 10 is a flowchart showing a procedure for measuring the quality of a frequency channel by the on-vehicle camera apparatus shown in FIG. 2;

FIG. 11 is a flowchart showing a receiving procedure performed by the on-vehicle monitor apparatus shown in FIG. 5;

FIG. 12 is a flowchart showing a procedure for switching a frequency channel by the on-vehicle monitor apparatus shown in FIG. 5; and

FIG. 13 is a flowchart showing a procedure for determining the quality of a frequency channel by the on-vehicle monitor apparatus shown in FIG. 5.

### DETAILED DESCRIPTION OF THE INVENTION

The invention will now be described by reference to the preferred embodiments. This does not intend to limit the scope of the present invention, but to exemplify the invention.

The present invention will now be outlined before it is described in detail. Exemplary embodiments of the present invention relate to a communication system. In this communication system, an on-vehicle camera apparatus generates image data by compressing the captured original frames and then transmits the thus generated image data, and an on-vehicle monitor apparatus, which receives the generated image data from the on-vehicle camera, reproduces image data. Here, the on-vehicle camera apparatus and the on-vehicle monitor apparatus are installed on a vehicle. Wireless LAN is used to transmit the image data to the on-vehicle monitor apparatus from the on-vehicle camera apparatus; packet signals are used in the wireless LAN. A plurality of frequency channels are defined in the wireless LAN, and it is desirable that a frequency channel having less interference is used. However, since the vehicle can move freely, such a frequency channel having less interference also varies as the surrounding circumstances vary. Here, the effect of interference varies depending on the circumstances where the radio communications are being performed. For instance, if the vehicle moves slow, the vehicle will suffer interference for a longer period of time; if the vehicle moves fast, the vehicle will suffer interference for a shorter period of time. Also, it is desirable that transmission interruption due to the switching of frequency channels be shorter. In order to cope with these, a communication system according to an exemplary embodiment carries out the following processings.

The radio apparatus included in the on-vehicle camera apparatus receives the image data and also receives vertical synchronization signals which are synchronized with the image data. The vertical synchronization signal contains periodically a vertical blanking interval (hereinafter referred to as “V blanking interval”) and no image data is contained in this V blanking interval. Using the V blanking interval, a radio apparatus measures the characteristics for a plurality of frequency channels, respectively. That is, the radio apparatus also measures the characteristics of frequency channels not used for the transmission, while the image data are being sent. Also, prior to the switching of frequency channels, the radio apparatus transmits beforehand a measurement result to the on-vehicle monitor apparatus. A radio apparatus included in the on-vehicle monitor apparatus receives the image data and also receives the measurement result. Based on the measurement result, the radio apparatus generates a table where the respective characteristics for a plurality of frequency channels are aggregated. The radio apparatus measures the quality of image data over a measurement period. Here, the measurement period is set such that faster the moving velocity is, longer the measurement period becomes. In other words, if the radio apparatus determines the switching of frequency channels because of deterioration in the quality of image data, the radio apparatus will determine a new frequency channel by referencing the table.

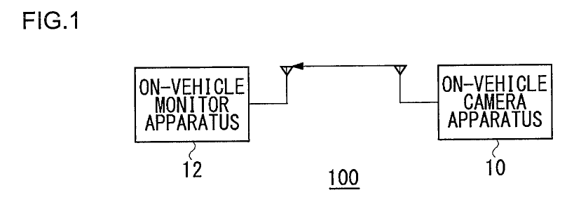

FIG. 1 shows a structure of a communication system 100 according to an exemplary embodiment of the present invention. The communication system 100 includes an on-vehicle camera apparatus 10 and an on-vehicle monitor apparatus 12. The communication system 100 is installed in a not-shown vehicle. The on-vehicle camera apparatus 10 picks up moving images or still images (hereinafter generically referred to as “images”) and transmits data of the picked-up images (hereinafter referred to as “image data”) to the on-vehicle monitor apparatus 12. Here, the image data are compressed using JPEG. As described above, wireless LAN is used for a radio network between the on-vehicle camera apparatus 10 and the on-vehicle monitor apparatus 12. Accordingly, a plurality of frequency channels are defined, and the on-vehicle camera apparatus 10 and the on-vehicle monitor apparatus 12 select and use a common frequency channel. If another vehicle (not shown), which is compatible with the communication system 100, approaches the vehicle and the same frequency channel is being used for each of the vehicles, interference occurs. A part of the plurality of frequency channels is also used for radar. In other words, interference with the radar may occur in a part of the frequency channels.

The on-vehicle monitor apparatus 12 receives image data from the on-vehicle camera apparatus 10 and displays the images on a monitor. During the transmission of the image data, the on-vehicle camera apparatus 10 measures the characteristics of a plurality of frequency channels, respectively, and transmits the thus measured characteristics to the on-vehicle monitor apparatus 12. The on-vehicle monitor apparatus 12 measures the quality of image data, and determines the switching of the current frequency channel to another frequency channel if the quality thereof deteriorates. In so doing, the on-vehicle monitor apparatus 12 selects a frequency channel, based on the measurement result sent from the on-vehicle camera apparatus 10.

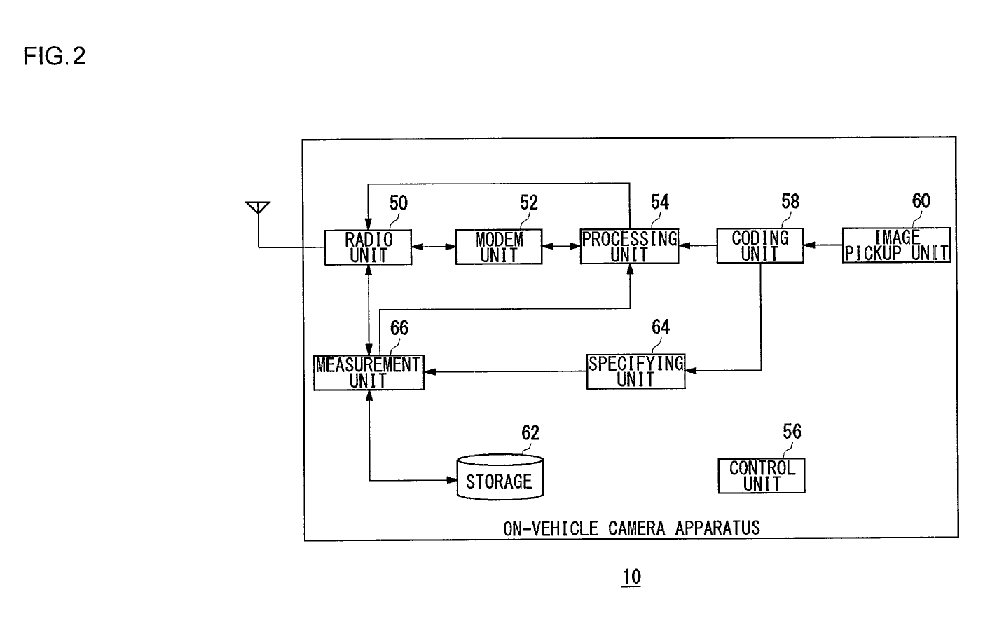

FIG. 2 shows a structure of an on-vehicle camera apparatus 10. The on-vehicle camera apparatus 10 includes a radio unit 50, a modem unit 52, a processing unit 54, a control unit 56, a coding unit 58, an image pickup unit 60, a storage 62, a specifying unit 64, and a measurement unit 66.

The image pickup unit 60, which is a CCD (Charge Coupled Device) image sensor or the like, picks up the images of original image frames. As described above, an original image frame corresponds to an image on which no compression is performed. In what is to follow, no distinction will be made between images per se and digital data, and the term “original image frame” will be used in general. Images are taken by the image pickup unit 60 on a periodic basis, for instance. The image pickup unit 60 outputs sequentially the captured original frames to the coding unit 58.

The coding unit 58 sequentially receives the input of original image frames from the image pickup unit 60. The coding unit 58 compresses and codes the original image frames so as to generate image data. For example, a motion JPEG (Joint Photographic Experts Group) scheme is used as a compression scheme. If, for instance, interlaces are used, each image data is comprised of odd-numbered field data (this will also be hereinafter referred to as “odd-numbered field”) and even-numbered field data (this will also be hereinafter referred to as “even-numbered field”).

The coding unit 58 appends a JPEG header to a position anterior to each odd-numbered field, and appends markers to the header and the tail, respectively. Here, the marker appended to the header is “SOI (Start of Image)”, whereas the marker appended to the tail is “EOI (End of Image)”. The JPEG header, SOI and EOI are also appended to each even-numbered field in the similar manner. Hereinafter, each odd-numbered field and even-numbered field to which the JPEG header, SOI and EOI are appended will also be referred to as “odd-number field” and “even-numbered field”. Note that the odd-numbered fields and the even-numbered fields are generically referred to as “image data” also. Further, the coding unit 58 generates vertical synchronization signals which are synchronized with a plurality of image data, respectively. The vertical synchronization signals may be those generated using any known technology, so that the description thereof is omitted here. The coding unit 58 outputs the image data to the processing unit 54 and outputs the vertical synchronization signals to the specifying unit 64.

As a transmit processing, the processing unit 54 receives sequentially the input of image data from the coding unit 58. The processing unit 54 stores the sequentially inputted image data in packet signals. If the size of a single piece of image data is larger than that of a packet signal, the processing unit 54 will divide the image data into a plurality of parts so that the image data can be stored in packet signals. That is, the processing unit 54 stores such a single piece of image data in a plurality of packet signals. The processing unit 54 outputs the packet signals to the modem unit 52.

As a receive processing, the processing unit 54 receives the input of decoding results from the modem unit 52. The processing unit 54 carries out processings according to the decoding results. One example of the decoding results is a request for the switching of frequency channels made from the on-vehicle monitor apparatus 12. In such a case, the request contains information on a new frequency channel. In accordance with this request, the processing unit 54 instructs the radio unit 50 to switch the current frequency channel to the new frequency channel. After instructing the radio unit 50 to switch the frequency channel, the processing unit 54 performs switching processing with the on-vehicle monitor apparatus 12 over the new frequency channel, via the modem unit 52 and the radio unit 50. A detailed description of switching processing is omitted here. Further, the processing unit 54 performs digital signal processing on the packet signals. One example of the digital signal processing is error correction coding as a transmit processing and error correction decoding as a receive processing. Note that the digital signal processing is not limited thereto.

As a transmit processing, the modem unit 52 modulates the packet signals outputted from the processing unit 54. Any modulation scheme may be used here. Further, the modem unit 52 outputs the modulated packet signals to the radio unit 50 as baseband packet signals. As a receive processing, the modem unit 52 demodulates the baseband packet signals outputted from the radio unit 50. Further, the modem unit 52 outputs the demodulation results to processing unit 54. If the communication system 100 is compatible with an OFDM modulation scheme (e.g., the IEEE 802.11a standard), the modem unit 52 will also perform FFT as a receive processing and also perform IFFT as a transmit processing. If the communication system 100 is compatible with a spread spectrum scheme (e.g., IEEE 802.11b), the modem unit 52 will also perform despreading as a receive processing and also perform spreading as a transmit processing. If the communication system 100 is compatible with a MIMO scheme (e.g., IEEE 802.11n), the modem unit 52 will also perform adaptive array signal processing as a receive processing and also perform distribute data streams to multiple streams as a transmit processing.

The radio unit 50 communicates wirelessly with the not-shown on-vehicle monitor apparatus 12. Following the instructions given by the processing unit 54, the radio unit 50 sets a frequency channel which is to be used for the radio communication, as described earlier. That is, the radio unit 50 uses any one of a plurality of frequency channels. As a transmit processing, the radio unit 50 receives the input of baseband packet signals from the modem unit 22. The radio unit 50 performs quadrature modulation on the baseband packet signals so as generate packet signals with intermediate frequency band. Further, the radio unit 50 generates radiofrequency-band packet signals by frequency-converting intermediate-frequency-band packet signals. The radiofrequency band corresponds to the frequency channel. After amplifying the radiofrequency-band packet signals, the radio unit 50 transmits the amplified radiofrequency-band packet signals via an antenna. A PA (Power Amplifier), a mixer and a D-A conversion unit are also included in the radio unit 50.

As a receive processing, the radio unit 50 generates intermediate-frequency-band packet signals by frequency-converting the radiofrequency-band packet signals received via the antenna. The radio unit 50 performs quadrature detection on the intermediate-frequency-band packet signals so as to generate baseband packet signals. The radio unit 50 outputs the baseband packet signals to the modem unit 52. The baseband packet signal, which is composed of in-phase components and quadrature components, shall generally be indicated by two signal lines. For the clarity of Figures, the baseband signal is presented here by a single signal line only. An LNA (Low Noise Amplifier), a mixer, an AGC (Automatic Gain Control) unit and an A-D conversion unit are also included in the radio unit 50.

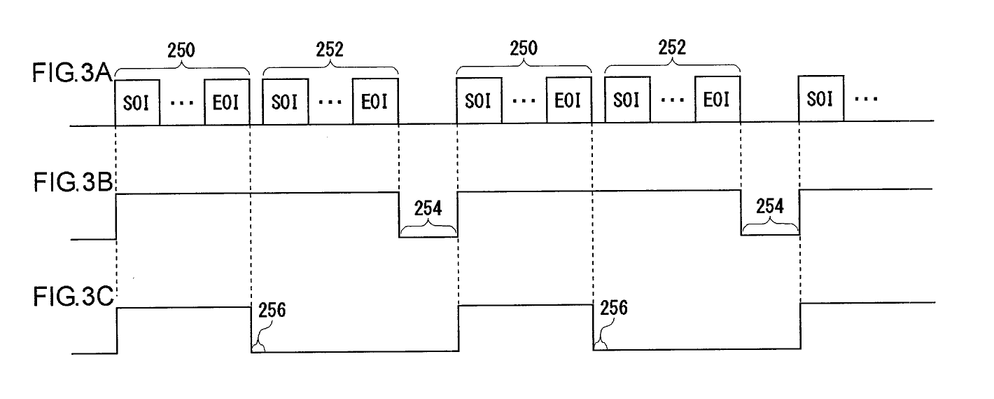

The specifying unit 64 receives the input of vertical synchronization signals from the coding unit 58. Here, a vertical synchronization signal is a signal that indicates a scanning frequency and a starting point of a scanning in a vertical scanning. That is, the vertical synchronization signal is a signal synchronized with the image data outputted from the coding unit 58. FIGS. 3A to 3C show operation timings in the on-vehicle camera apparatus 10. In each of FIGS. 3A to 3C, the horizontal axis represents time. FIG. 3A shows image data from the coding unit 58. “SOI” and “EOI” are appended to the beginning of each odd-numbered field 250 and the tail end thereof, respectively. Similarly, “SOI” and “EOI” are appended to the beginning of each even-numbered field 252 and the tail end thereof, respectively. Pairs of odd-numbered fields 250 and even-numbered fields 252 are continuously assigned.

FIG. 3B shows a vertical synchronization signal. As shown in FIG. 3B, the vertical synchronization signal is a signal that goes “high” in an interval during which the odd-numbered field 250 and the even-numbered field 252 are contiguous, and goes “low” between the end timing of the even-numbered field 252 and the next odd-numbered field 250. Here, the interval during which the vertical synchronization signal goes “low” corresponds to a V blanking interval 254. FIG. 3C will be discussed later. Now refer back to FIG. 2. The specifying unit 64 specifies the V blanking interval 254 in the vertical synchronization signal, as the synchronization period for the image data inputted sequentially. The specifying unit 64 outputs the thus specified V blanking interval 254 to the measurement unit 66.

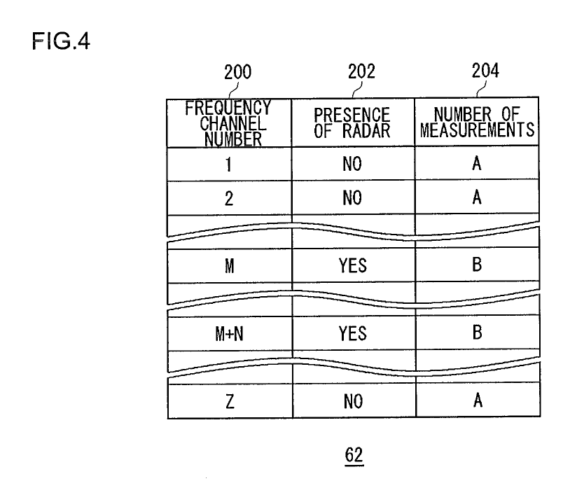

The measurement unit 66 receives the input of the V blanking interval 254 from the specifying unit 64. The measurement unit 66 measures the characteristics of a radio channel over the V blanking interval 254, via the radio unit 50. A detailed description is further given here of measurement processing. Prior to the actual measurement, the measurement unit 66 acquires measurement conditions stored in the storage 62. FIG. 4 shows a data structure of measurement conditions stored in the storage 62. As shown in FIG. 4, the measurement conditions include a frequency channel number space 200, a presence-of-radar space 202, and a number-of-measurements space 204. The frequency channel number space 200 indicates numbers by which to identify a plurality of frequency channels, respectively (hereinafter referred to as “frequency channel numbers”). Note that each frequency channel number is associated with a frequency value.

The presence-of-radar space 202 indicates whether radar is allocated to each frequency channel or not. When “yes” is indicated in the presence-of-radar space 202, radar is allocated; when “no”, no radar is allocated. The number-of-measurements space 204 indicates the number of measurements required for the measurement of each frequency channel. Though, as described earlier, the measurement unit 66 carries out measurement in the V blanking interval 254, the V blanking interval 254 is, for instance, several msecs or so and is generally shorter than a period required for the measurement in each frequency channel. In order to cope with this, the measurement unit 66 carries out measurement a plurality of times in the V blanking interval 254 for each frequency channel.

The measurement unit 66 accumulates a plurality of measurement results so as to derive a measurement result for a frequency channel. That is, in order to measure the characteristics of radio channel for a frequency channel, the measurement unit 66 uses a plurality of V blanking intervals 254. The number of V blanking intervals 254 used in the measurement is indicated in the number-of-measurements space 204. In the case of FIG. 4, the number of measurements for a frequency channel to which no radar is allocated is “A”, whereas the number of measurements for a frequency channel to which radar is allocated is “B”. Assume that B is greater than A. That is, the number of V blanking intervals 254 to be used for the measurement is varied according to each frequency channel. Now refer back to FIG. 2

Based on the measurement condition as shown in FIG. 4, the measurement unit 66 not only specifies the number of measurements for a frequency channel but also measures the electric power of signal received via the radio unit 50 during the V blanking interval 254. The measurement unit 66 repeats the measurement until the specified number of measurements is met, and the measurement unit 66 accumulates the received powers when the number of measurements is met. Further, the measurement unit 66 repeats the similar measurement for another frequency channel, based on a condition. The measurement unit 66 outputs the electric power for each frequency to the processing unit 54 as a measurement result.

The processing unit 54 also receives the input of a measurement result from the measurement unit 66. The processing unit 54 stores the measurement results in the packet signals. Here, the processing unit 54 also receives the input of field synchronization signals from the coding unit 58. FIG. 3C is now referred to for the explanation of field synchronization signal. The field synchronization signal is a signal that goes “high” over each odd-numbered field 250 interval, and goes “low” for the remaining intervals, so that the field synchronization signal may serve to distinguish the odd-numbered fields 250 from the even-numbered fields 252 and vice versa.

Based on the field synchronization signal, the processing unit 54 specifies an inter-field blanking interval as a period between an odd-numbered field 250 and an even-numbered field 252. In other words, the processing unit 54 specifies a predetermined interval after a field synchronization signal is switched from high to low. In the specified interval, the processing unit 54 transmits the packet signals via the modem unit 52 and the radio unit 50. That is, the packet signals in which the measurement results are stored are transmitted in the inter-field blanking intervals 256 which are intervals other than the odd-numbered fields 250, the even-numbered fields 252 and the V blanking intervals 254. The control unit 56 controls the whole operation of the on-vehicle camera apparatus 10.

The structure as described above may be achieved hardwarewise by elements such as a CPU, memory and other LSIs of an arbitrary computer, and softwarewise by memory-loaded programs having communication functions or the like. Depicted herein are functional blocks implemented by cooperation of hardware and software. Therefore, it will be obvious to those skilled in the art that the functional blocks may be implemented by a variety of manners including hardware only, software only or a combination of both.

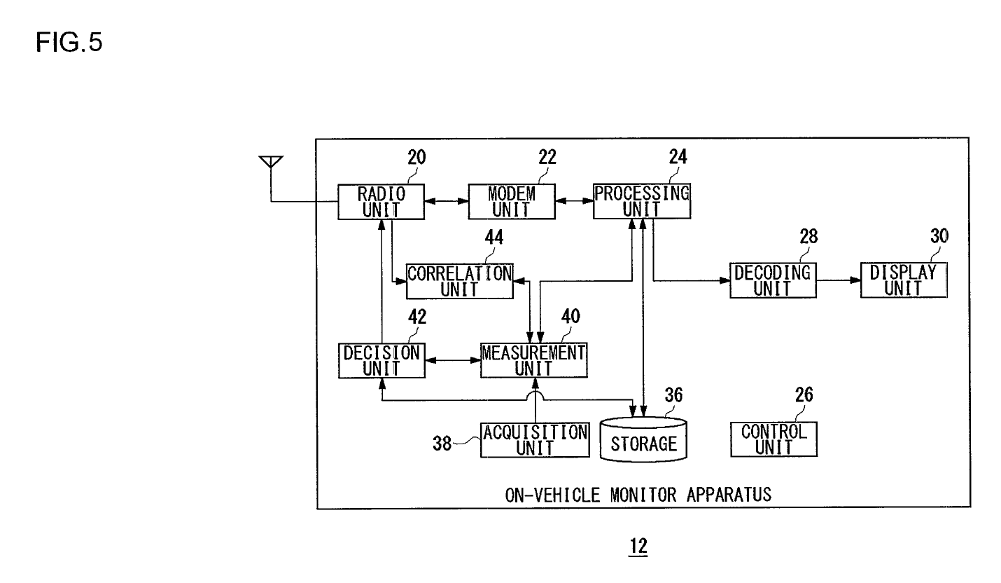

FIG. 5 shows a structure of an on-vehicle monitor apparatus 12. The on-vehicle monitor apparatus 12 includes a radio unit 20, a modem unit 22, a processing unit 24, a control unit 26, a decoding unit 28, a display unit 30, a storage 36, an acquisition unit 38, a measurement unit 40, a decision unit 42, and a correlation unit 44. Since the radio unit 20, the modem unit 22 and the processing unit 24 are of the same type as the radio unit 50, the modem unit 52 and the processing unit 54 shown in FIG. 2, respectively, a description is given hereinbelow of the on-vehicle monitor apparatus 12 centering around the difference.

The processing unit 24 receives the input of image data, which are obtained as a result of decoding by the modem unit 22, from a on-vehicle camera apparatus 10 (not shown). The processing unit 24 performs digital signal processing, such as error correction decoding, on the image data. The processing unit 24 outputs the image data which have been subjected to the digital signal processing (hereinafter also referred to as “image data”) to the decoding unit 28. The decoding unit 28 receives the input of the image data from the processing unit 24. Since the image data are compressed in compliance with JPEG, the decoding unit 28 decodes the image data. Any known technique may be used for the decoding, so that the description thereof is omitted here. The decoding unit 28 outputs image frames, which are obtained as a result of decoding, to the display unit 30. The image frames may be identical to the original image frames. The display unit 30 is structured by an LCD (Liquid Crystal Display) and the like. The display unit 30 receives the image frames from the decoding unit 28 and displays the image frames.

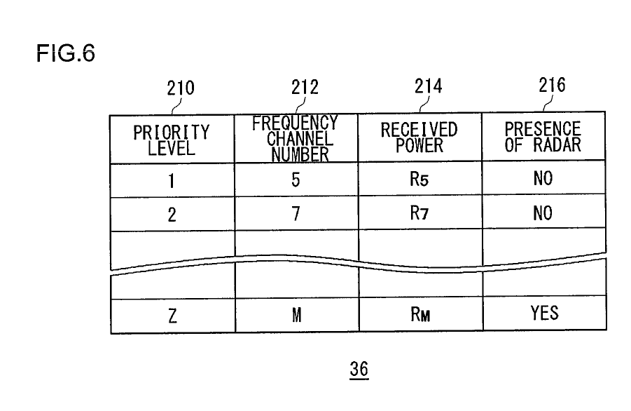

The processing unit 24 receives a measurement result as appropriate from the not-shown on-vehicle camera apparatus 10 via the radio unit and the modem unit 22. Upon receipt of the measurement result, the processing unit 24 updates the table, containing the measurement result, which is stored in the storage 36. FIG. 6 shows a data structure of the table, containing measurement results, which is stored in the storage 36. As shown in FIG. 6, the table contains a priority level space 210, a frequency channel number space 212, a received power space, and a presence-of-radar space 216. Here, the frequency channel number space 212 and the presence-of-radar space 202 correspond respectively to the frequency channel number space 200 and the presence-of-radar space 202 of FIG. 4. The received power contained in the measurement results is shown in the received power space 214.

The processing unit 24 extracts a frequency channel number and a received power from the measurement results, and specifies a corresponding row from the frequency channel number space 212 based on a frequency channel. The processing unit 24 enters the received power into the specified row in the received power space 214. Further, the processing unit 24 compares the received powers with one another and updates the data in the table in such a manner that a higher priority level, namely, a smaller number in priority level is given to a frequency channel number having a lower received power. The priority level for each frequency channel is indicated in the priority level space 210. Since the received power corresponds to the interference power, a higher priority level is given to a frequency channel having a lower interference power. Now refer back to FIG. 5.

The acquisition unit 38 is connected to a not-shown speed sensor of a vehicle installing the on-vehicle monitor apparatus 12 therein, and acquires the travelling speed of the vehicle using the speed sensor. For instance, the acquisition unit 38 acquires the travelling speed thereof at predetermined intervals. Since any known technique may be used to realize the speed sensor, the description thereof is omitted here. The acquisition unit 38 outputs information on the travelling speed to the measurement unit 40. The measurement unit 40 receives successively the information on the travelling speed from the acquisition unit 38. The measurement unit 40 determines a threshold value for the travelling speed. The threshold value therefor is used to determine the measurement period.

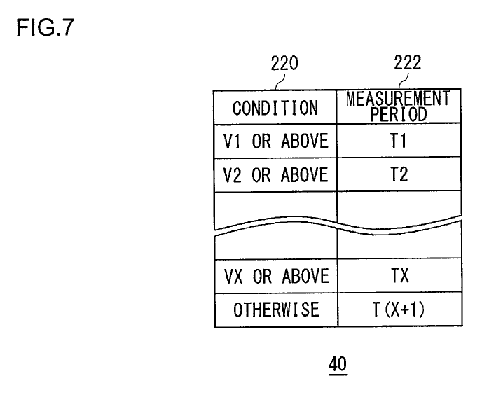

FIG. 7 shows a data structure of a threshold value, with which to determine the measurement period, stored in the measurement unit 40. As shown in FIG. 7, the data structure includes a condition space 220 and a measurement period space 222. The condition space 220 indicates the conditions for the travelling speeds, and the measurement period space 222 indicates the measurement periods that meet the conditions on the left, respectively. Here, the travelling speeds are set such that V1>V2> . . . >VX, and the measurement periods are set such that T1>T2> . . . >TX>T(X+1). In other words, the travelling speed and the measurement period are defined such that the faster the travelling speed, the longer the measurement period will be. The measurement unit 40 sequentially extracts conditions starting from the top of the condition space 220, and compares the extracted condition with the travelling speed. If the travelling speed meets the condition, the measurement unit 40 will specify a measurement period associated with the condition in question. Now refer back to FIG. 5.

The measurement unit 40 measures the characteristics of a frequency channel used by the radio unit 20 for a specified measurement period. Specifically, the measurement unit 40 measures the error rate of packet signals, received by the processing unit 24, via the radio unit 20 and the modem unit 22. Here, the packet signals are transmitted from the not-shown on-vehicle camera apparatus 10. Since any known technique may be used for the measurement of the error rate, the description thereof is omitted here. If the frequency channel used by the radio unit 20 is not allocated to radar, namely, if used is the frequency channel where “no” is indicated in the presence-of-radar space 216 of FIG. 6, the measurement unit 40 will measure only the error rate as the characteristics of the frequency channel. The measurement unit 40 outputs the measured error rate to the decision unit 42.

On the other hand, if the frequency channel used by the radio unit 20 is also allocated to radar, namely, if used is the frequency channel where “yes” is indicated in the presence-of-radar space 216 of FIG. 6, the measurement unit 40 will input not only the error rate but also a correlation value sent from the correlation unit 44, as the characteristics of the frequency channel. As the correlation unit 44 receives a received signal from the radio unit 20, the correlation unit 44 converts the received signal from the time domain into the frequency domain. This conversion may be done using FFT. The correlation unit 44 stores beforehand the frequency characteristics of radar and calculates a value of correlation between the frequency characteristics of radar and the received signal in the frequency domain. The correlation unit 44 outputs the calculated correlation value to the measurement unit 40. Here, a period over which the correlation value is calculated differs from the aforementioned measurement period, and is defined as a fixed period irrespective of the travelling speed. Note that calculating the correlation value corresponds to measuring the interference amount of radar. The measurement unit 40 outputs the correlation value to the decision unit 42.

The decision unit 42 receives the error rate from the measurement unit 40. The decision unit 42 compares the error rate against a threshold value. If the error rate deteriorates exceeding the threshold value, the decision unit 42 will determine that the quality of a frequency channel is deteriorated. If, on the other hand, the error rate does not deteriorate, the decision unit 42 will determine that the quality of a frequency channel is not deteriorated. There may be cases where the decision unit 42 receives the correlation value from the measurement unit 40. The decision unit 42 compares the correlation value against another threshold value. If the correlation value is larger than the threshold value, the decision unit 42 will determine that the Quality of a frequency channel is deteriorated. If, on the other hand, the correlation value is not larger than the threshold value, the decision unit 42 will determine that the quality of a frequency channel is not deteriorated.

If the decision unit 42 determines that the quality of a frequency channel is deteriorated, the decision unit 42 will determine the switching from the frequency channel being used by the radio unit 20 to another frequency channel among a plurality of frequency channels. In so doing, the decision unit 42 references the table stored in the storage 36 and selects a frequency channel whose priority level is the highest, namely a frequency channel having the smallest number in priority level. Note that the frequency channel currently in use is excluded in this selection. The decision unit 42 instructs the radio unit 20 to switch it to the selected frequency channel. The radio unit 20 switches the frequency channel by following the instructions given from the decision unit 42. Further, the decision unit 42 transmits a signal requesting the switching of the frequency channel, to the not-shown on-vehicle camera apparatus 10 via the processing unit 24, the modem unit 22 and the radio unit 20. The control unit 26 controls the whole operation of the on-vehicle monitor apparatus 12.

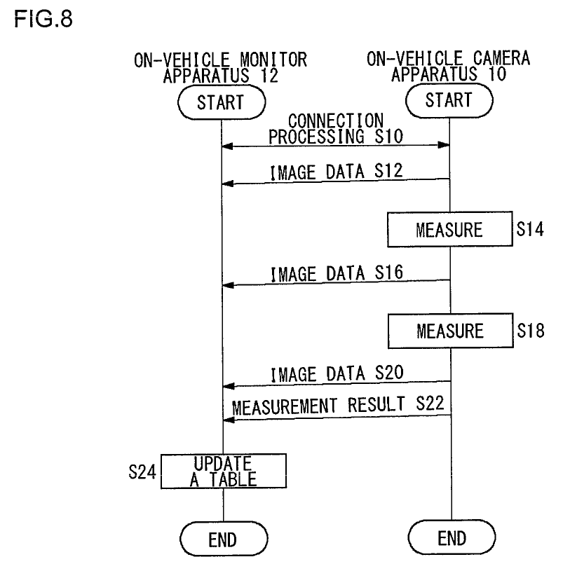

An operation of the communication system 100 structured as above will now be described. FIG. 8 is a sequence diagram showing a procedure for updating a table in the communication system 100. The on-vehicle camera apparatus 10 and the on-vehicle monitor apparatus 12 perform connection processings (S10). The on-vehicle camera apparatus 10 transmits image data to the on-vehicle monitor apparatus 12 (S12). The on-vehicle camera apparatus 10 measures the characteristics of a radio channel at timing during which the image data are not being transmitted (S14). Then the on-vehicle camera apparatus 10 transmits the image data to the on-vehicle monitor apparatus 12 (S16).

Further, the on-vehicle camera apparatus 10 measures the characteristics of a radio channel for the frequency channel at timing during which the image data are not being transmitted (S18). Then the on-vehicle camera apparatus 10 transmits the image data to the on-vehicle monitor apparatus 12 (S20). Also, the on-vehicle camera apparatus 10 transmits a measurement result to the on-vehicle monitor apparatus 12 (S22). For simplicity of explanation, assume herein that the aforementioned number of measurements is “2”. The on-vehicle monitor apparatus 12 updates the table, based on the measurement result (S24). The processings by Step 14, Step 18 and Step 22 are repeated by varying the frequency channel.

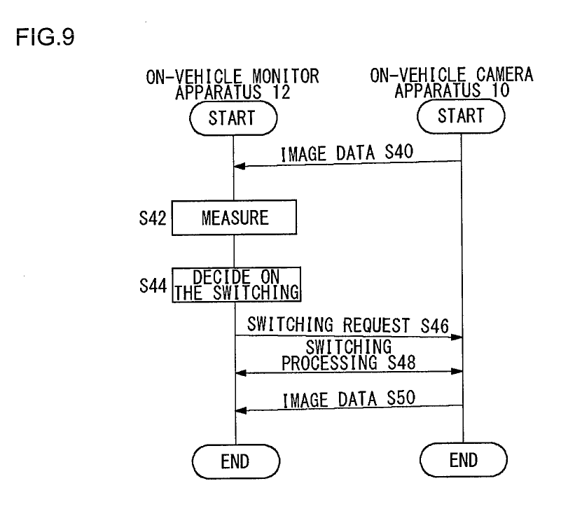

FIG. 9 is a sequence diagram showing a procedure for switching a frequency channel in the communication system 100. The on-vehicle camera apparatus 10 transmits image data to the on-vehicle monitor apparatus 12 (S40). The on-vehicle monitor apparatus 12 measures the error rate of the image data (S42). The on-vehicle monitor apparatus 12 determines the switching of the frequency channel, based on the error rate (S44). The on-vehicle monitor apparatus 12 transmits a switching request to the on-vehicle camera apparatus 10 (S46). The on-vehicle camera apparatus 10 and the on-vehicle monitor apparatus 12 carry out switching processings (S48). The on-vehicle camera apparatus 10 transmits the image data to the on-vehicle monitor apparatus 12 over a new frequency channel (S50).

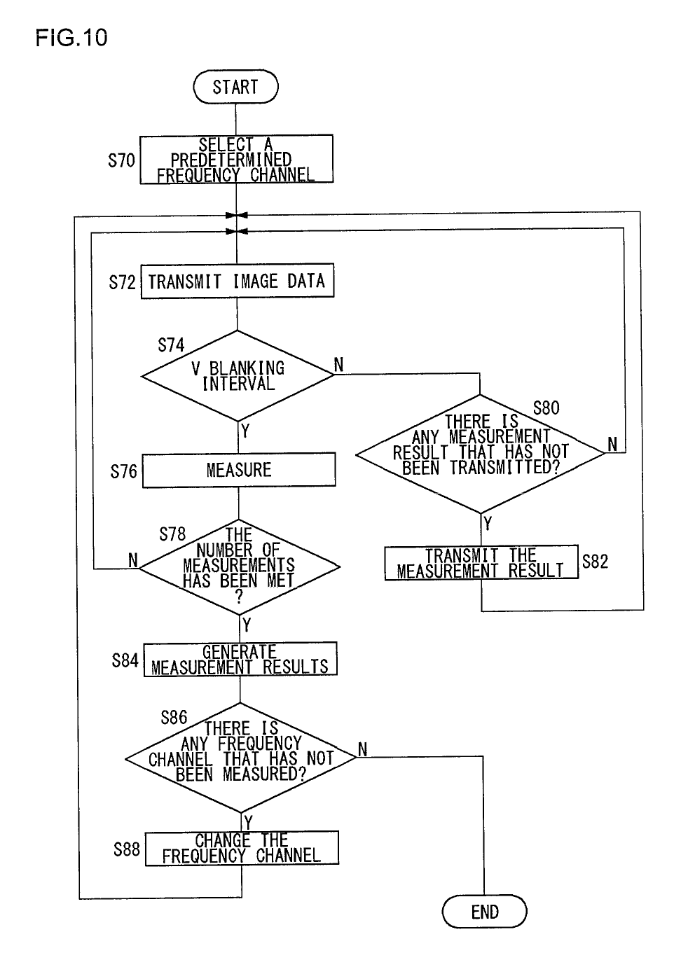

FIG. 10 is a flowchart showing a procedure for measuring the quality of a frequency channel by the on-vehicle camera apparatus 10. The measurement unit 66 selects a predetermined frequency channel which is to be measured (S70). The processing unit 54, the modem unit 52 and the radio unit 50 transmit the image data sent from the coding unit 58 (S72). As the specifying unit 64 specifies a V blanking interval (Y of S74), the measurement unit 66 measures the characteristics of a radio channel (S76). If the number of measurements has not been met (N of S78), return to Step 72. If, on the other hand, the number of measurements is met (Y of S78), the processing unit 54 will generate a measurement result (S84).

If there is any frequency channel which has not been measured (Y of S86), the measurement unit 66 will change the frequency channel (S88) and the processing will be returned to Step 72. If there is no frequency channel which has not been measured (N of S86), the processing will be terminated. If the specifying unit 64 does not specify any V blanking interval (N of S74) and there is any measurement result which has not been transmitted (Y of S80), the processing unit 54 will transmit the measurement result via the modem unit 52 and the radio unit 50 (S82) and the processing will be returned to Step 72. If there is no measurement result which has not been transmitted (N of S80), return to Step 72.

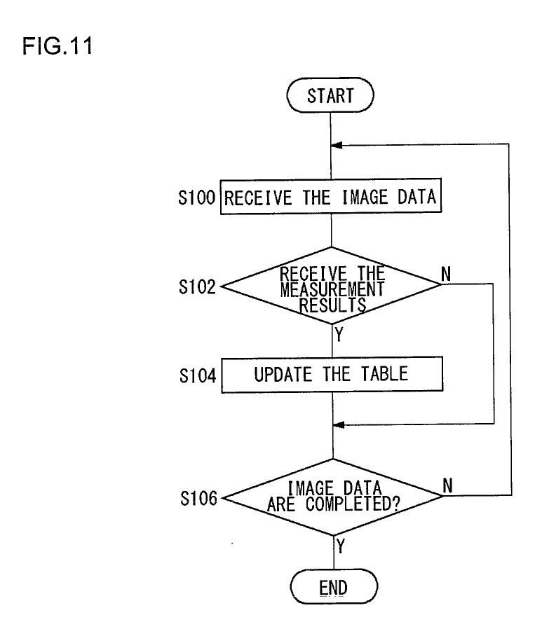

FIG. 11 is a flowchart showing a receiving procedure performed by the on-vehicle monitor apparatus 12. The processing unit 24 receives the image data via the radio unit 20 and the modem unit 22 (S100). If the processing unit 24 receives the measurement result via the radio unit 20 and the modem unit 22 (Y of S102), the processing unit 24 will update the table stored in the storage 36 (S104). If, on the other hand, the processing unit 24 does not receive the measurement result via the radio unit 20 and the modem unit 22 (N of S102), the processing unit 24 will skip Step 104. If the image data are not completed (N of S106), return to Step 100. If the image data are completed (Y of S106), the processing will be terminated.

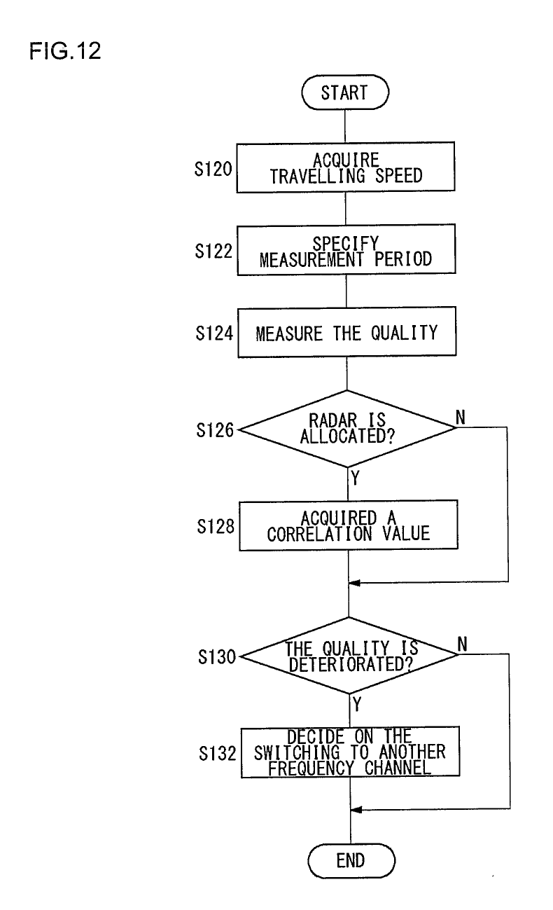

FIG. 12 is a flowchart showing a procedure for switching a frequency channel by the on-vehicle monitor apparatus 12. The acquisition unit 38 acquires travelling speed (S120). The measurement unit 40 specifies a measurement period (S122) and measures the quality (S124). If radar is allocated to the frequency channel in use (Y of S126), the correlation unit 44 will acquire a correlation value (S128). If radar is not allocated to the frequency channel in use (N of S126), Step 128 will be skipped. If the quality is deteriorated (Y of S130), the decision unit 42 will determine the switching of the frequency channel in use to another frequency channel (S132). If the quality is not deteriorated (N of S130), Step 132 will be skipped.

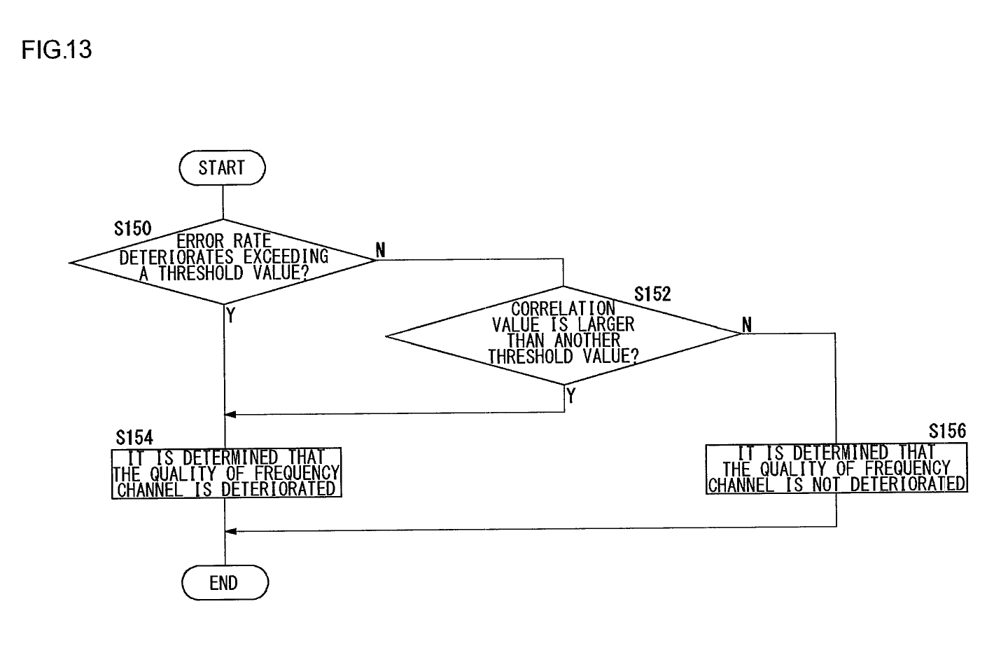

FIG. 13 is a flowchart showing a procedure for determining the quality of a frequency channel by the on-vehicle monitor apparatus 12. FIG. 13 corresponds to Step 130 of FIG. 12. If the error rate deteriorates exceeding a threshold value (Y of S150), the decision unit 42 will determine that the quality of a frequency channel is deteriorated (154). If, on the other hand, the error rate does not deteriorate exceeding the threshold value (N of S150) and the correlation value is larger than another threshold value (Y of S152), the decision unit 42 will determine that the quality of a frequency channel is deteriorated (S154). If the correlation value is not larger than the another threshold value (N of S152), the decision unit 42 will determine that the quality of a frequency channel is not deteriorated (S156).

By employing the present exemplary embodiments, the characteristics of a radio channel are measured while the image data are being transmitted, so that the characteristics of a radio channel can be acquired beforehand. Since the characteristics of a radio channel is acquired beforehand, information can be provided which is used to select a frequency channel appropriately according to the circumstances where the radio communication is being performed. Since the information used to select a frequency channel appropriately is provided, the frequency channel can be selected suitably. Since the characteristics of a radio channel are measured during a vertical blanking interval, the effect of image data on the transmission can be minimized.

Though each measurement period is comparatively short, a plurality of numbers of measurement results are merged into a single measurement result and therefore the deterioration of accuracy in the measurement result can be suppressed. Since the number of measurements is adjusted according as the radar is allocated or not, the measurement according to the frequency channel can be made. Also, since the number of measurements is adjusted according as the radar is allocated or not, both the accuracy in the measurement result and the improvement in the measurement efficiency can be achieved. Since the measurement result is transmitted in a period during which the image data are not being transmitted and the measurement is not being made, the effect of the image data on the transmission and measurement can be minimized.

Also, the measurement period according to the travelling speed is set, so that the accuracy in measurement can be enhanced. Since the measurement period according to the travelling speed is set, the switching of a frequency channel can be appropriately determined according to the circumstance where the radio communication is being performed. As the travelling speed increases, the measurement period is made longer, which can check the recovery of the quality of a frequency channel in the event that the quality thereof gets deteriorated. Thus the unnecessary switching of a frequency channel can be avoided. Since the unnecessary switching of a frequency channel is avoided, the stability of the communication system can be maintained.

As the travelling speed decreases, the measurement period is made shorter, which can instantly switch the frequency channel. Since a new frequency channel is predetermined, the switching processing time can be reduced. Where radar is allocated to a frequency channel in use, the value of correlation between the frequency characteristics of radar and the received signal are examined, so that the signal from the radar can be detected. Since the signal from the radar is detected, the interference with the radar can be reduced.

The present invention has been described based on the exemplary embodiments. The exemplary embodiments are intended to be illustrative only, and it is understood by those skilled in the art that various modifications to constituting elements and processes could be developed and that such modifications are also within the scope of the present invention.

In the present exemplary embodiments described above, the specifying unit 64 specifies a V blanking interval as the synchronization period for the image data. However, this should not be considered as limiting and, for example, the specifying unit 64 may specify the period from when the EOI of image data is first detected until when the SOI of the next image data is detected. In particular, if progressive method is employed, said period and the V blanking interval are associated with each other. According to this modification, the synchronization period is specified using the image data alone, so that the processing can be simplified.

In the exemplary embodiments described above, JPEG is used to compress the original image frames. However, this should not be considered as limiting and, for example, the on-vehicle camera apparatus 10 and the on-vehicle monitor apparatus 12 may use other compression techniques than JPEG. Not only still images but also moving images may be compressed. For example, MPEG (Moving Picture Experts Group) is used to compress the moving images. According to this modification, the exemplary embodiments of the present invention and their modifications are applicable to various types of compression techniques.

In the present exemplary embodiments described above, the on-vehicle camera apparatus 10 transmits the packet signals containing the measurement result in a period other than the periods during which the packet signals containing the image data are being transmitted and each frequency channel is being measured. However, this is not limited thereto. For example, the on-vehicle camera apparatus 10 may transmit the packet signals containing the measurement during an H blanking interval, and the on-vehicle camera apparatus 10 may transmit the packet signals in such a manner that the measurement result is inserted into an unused part of the header of packet signal containing the image data. Or the on-vehicle camera apparatus 10 may use such periods in combination. According to this modification, the measurement result can be transmitted immediately.

In the present exemplary embodiments described above, the acquisition unit 38 acquires the travelling speed via the speed sensor. However, this is not limited thereto and, for example, the acquisition unit 38 may estimate the travelling speed based on the variation in RSSI (Received Signal Strength Indicator) in the radio unit 20 and the variation in the error rate in the processing unit 24. According to this modification, the processing can be accomplished using the on-vehicle monitor apparatus 12 only, so that the on-vehicle monitor apparatus 12 can be mounted on a vehicle with ease.

In this modification as well as the above-described exemplary embodiments, the measurement unit 40 measure the quality of a frequency channel and the error rate. However, this should not be considered as limiting and, for example, the measurement unit 40 may measure EVM (Error Vector Magnitude) as the quality of a frequency. According to this modification, a variety of parameters can be used to measure the quality of a channel.

While the preferred embodiments of the present invention have been described using specific terms, such description is for illustrative purposes only, and it is to be understood that changes and variations may be further made without departing from the spirit or scope of the appended claims.

What is claimed is:

1. A radio apparatus, comprising:
an input unit which receives input of image data sequentially;
a specifying unit which specifies a synchronization period for the image data sequentially inputted by said input unit;
a measurement unit which measures the characteristics of a radio channel over the synchronization period specified by said specifying unit; and
a transmitter which stores the characteristics of a radio channel measured by said measurement unit in a radio packet and transmits the radio packet storing the measured characteristics thereof to another radio apparatus and which further stores the image data sequentially inputted by said input unit in the radio packet and transmits the radio packet storing said image data to the another radio apparatus.

2. A radio apparatus according to claim 1, wherein said specifying unit specifies a vertical blanking interval in a vertical synchronization signal for the image data, as the synchronization period for the image data sequentially inputted by said input unit.

3. A radio apparatus according to claim 1, wherein an identifier is each assigned to a header and a tail in each of the image data sequentially inputted by said input unit,
wherein said specifying unit specifies a period from when the identifier of a tail in predetermined image data is detected until when the identifier of a header of the next image data is detected, as the synchronization signal for the image data sequentially inputted by said input data.

4. A radio apparatus according to claim 1, wherein said transmitter uses any one of a plurality of frequency channels to transmit the radio packet, and
wherein said measurement unit uses a plurality of synchronization periods to measure the characteristics of a radio channel for each of the frequency channels.

5. A radio apparatus according to claim 4, wherein said measurement unit varies the number of synchronization periods to be used for measuring the characteristics thereof, according to each of the frequency channels.

6. A radio apparatus according to claim 1, wherein said transmitter transmits the radio packet storing the characteristics of a radio channel measured by said measurement unit, in a period other than the synchronization period specified by said sync period specifying period and a period during which the radio packet containing the image data is being transmitted.

7. A communication method, comprising:
receiving input of image data sequentially;
specifying a synchronization period for the image data inputted sequentially;
measuring the characteristics of a radio channel over the specified synchronization period; and
storing the measured characteristics of a radio channel in a radio packet, transmitting the radio packet storing the measured characteristics thereof to another radio apparatus, further storing the sequentially inputted image data in the radio packet and transmitting the radio packet storing said image data to the another radio apparatus.
